(19) United States
(12) Patent Application Publication
(10) Pub. No.: US 2006/0277062 A1
(43) Pub. Date: Dec. 7, 2006

(54) Preventive healthcare and prescription medication incentive compliance system and method

(76) Inventors: Travis J. Leonardi, Lighthouse, FL (US); Paul Averill, Royal Palm Beach, FL (US)

Correspondence Address: Steven M. Greenberg, Esq.;Christopher & Weisberg, P.A., Suite 2040, 200 East Las Olas Boulevard, Fort Lauderdale, FL, 33301, US

(21) Appl. No.: 11/142,645

(22) Filed: Jun. 1, 2005

(51) Int. Cl. G06Q 10/00

(52) U.S. Cl. 705/2

(57) ABSTRACT

A method and system for allowing patients to receive preventive healthcare services and low-cost pharmaceuticals through a physician who is not a member of a preventive healthcare program but who enjoys a referral-based association with a physician who is already affiliated with the preventive healthcare program. The present system and method determines the identity of the physician who has prescribed or who is associated with the prescription of pharmaceuticals to a patient who is a member of a preventive healthcare program. If the prescribing physician is not a member of the preventive healthcare program, a query is made of all member physicians to determine if any of the member physicians enjoy a referral relationship with the prescribing physician. If such a relationship exists, the prescribing physician is designated as a “referral physician” and may continue to be associated with the prescribing of pharmaceuticals to the patient under the terms of the preventive healthcare program.

### BACKGROUND OF THE INVENTION

1. Statement of the Technical Field

The present invention relates to preventive healthcare services and more particularly to a method and system for providing patients with low-cost pharmaceuticals by cross-referencing a physician who is associated with the prescription for the pharmaceuticals to ensure that the physician maintains a referral relationship with a physician that is a member of a federal drug discount program.

2. Description of the Related Art

Throughout the years, there have been many advances in modern medicine relating to the mode of treatment of patients, and especially with regard to preventive healthcare services and pharmaceuticals that are available to prevent disease and treat patients. In particular, drug manufacturers are devoting large amounts of their resources into research and development of new pharmaceuticals, many of which are proving to be effective in the treatment of long suffering patients. However, based upon the business model typically associated with the development and marketing of these innovative pharmaceuticals, and the virtual monopolies over certain medications that are often established by the pharmaceutical manufactures such as based upon patent protection and/or trade secret protection, the end cost of the pharmaceuticals to consumers is often very high. Indeed, while it is recognized that pharmaceutical development is a business aimed to the development of profits, the critical need of the pharmaceutical by patients, as well as the subsidization of the purchase of the pharmaceuticals by insurance companies and/or the Medicaid program, all have a tendency to promote the maintenance of high pharmaceutical prices by the manufacturers.

Unfortunately, in addition to the patients that have effective insurance coverage to help subsidize the purchase of necessary pharmaceuticals, there are also a large number of patients who do not have adequate insurance coverage and/or are merely members of discount card type programs. As a result, these patients must pay a substantial price for the purchase of necessary pharmaceuticals. Furthermore, it is also recognized that as the healthcare system changes, the practice of large percentage subsidization of pharmaceutical costs, even for insured patients covered by Medicaid or other policies, has an uncertain future. As a result, many current patients, as well as many patients in the future, are left to independently pay a substantial amount of the bill for the pharmaceuticals that are essential to their healthcare needs.

In recognizing the difficulties and perhaps the burden associated with having to purchase a continuous regimen of necessary pharmaceuticals at the often high pharmaceutical company prices, the United States government enacted its Public Health Services Act into law whereby certain healthcare facilities could be qualified as Federally Qualified Healthcare Centers or Federally Qualified Healthcare Center equivalents (both, for purposes of clarity referred to as an “FQHC” in the present document) or disproportionate share hospitals as governed under Title 18 of the Social Security Act, and could therefore be eligible to participate in a federal drug discount program.

In particular, in exchange for Medicaid qualification for their products and/or other benefits to the pharmaceutical companies, the pharmaceutical companies agreed to provide their pharmaceuticals to the FQHCs or qualified disproportionate share hospitals based upon an established discount cost schedule. As a result, patients of the FQHCs or disproportionate share hospitals would have the benefit of the pharmaceuticals at a reduced cost. Typically, FQHCs include indigent healthcare facilities, veteran facilitates as well as other federally organized healthcare facilities, including Indian tribal healthcare facilities. Unfortunately, however, for the typical patient, ordinary individuals suffering from chronic illnesses requiring extensive and expensive pharmaceuticals are traditionally not qualified patients of the FQHCs or disproportionate share hospitals and are thus not eligible for the discounted medication.

Often, a patient who is a member of a federal drug discount program maintains a doctor-patient relationship with his or her prior physician, who in the past has filled in prescriptions on behalf of the patient. However, there are instances where the patient's prior physician may not be eligible to prescribe medications under the drug discount program. Thus, the patient is put in a situation where he or she has become a member of the federal drug discount program but still prefers to receive prescribed pharmaceuticals via their prior physician who is not a member of the program.

It would therefore be desirable to provide a method and system that allows patients that are members of a preventive healthcare program to receive discounted pharmaceuticals from a physician who is not a member of the program but enjoys a referral relationship with another physician that is already a member of the federal drug discount.

### SUMMARY OF THE INVENTION

The present invention relates to a method and system of providing patients with beneficial preventive healthcare services in a manner that also provides them with access to necessary pharmaceuticals at a reduced cost below what they would normally pay for such pharmaceuticals. Specifically, the method and system of the present invention allows patients to receive low-cost pharmaceuticals through a preventive healthcare program and a physician who is not a member of the preventive healthcare program but who enjoys a referral-based association with a physician who is already affiliated with the preventive healthcare program.

In one aspect of the invention, a method for providing a patient with access to prescribed pharmaceuticals via a preventive healthcare program is provided. The pharmaceuticals are prescribed by a physician who is not a member of the preventive healthcare program. The method includes qualifying a healthcare facility as a disproportionate share hospital eligible to participate in the preventive healthcare program, where the qualified healthcare facility is associated with at least one qualified physician. It is then determined if there is a relationship between the non-member physician and at least one qualified physician. Through the preventive healthcare program, if there exists a relationship between the non-member physician and the at least one qualified physician, pharmaceuticals may be provided to the patient at a discounted cost utilizing the preventive healthcare program.

In another aspect of the invention, a system for providing a patient with access to pharmaceuticals via a preventive healthcare program is provided. The pharmaceuticals are prescribed by a physician who is not a member of the preventive healthcare program. The system includes a healthcare facility that qualifies as a disproportionate share hospital eligible to participate in the preventive healthcare program. The healthcare facility is associated with at least one qualified physician. The healthcare facility is adapted to determine if there is a relationship between one of the qualified physicians and the non-member physician, wherein if there is a relationship between one of the qualified physicians and the non-member physician, the patient may receive the prescribed pharmaceuticals at a reduced cost.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a diagram of an exemplary system constructed in accordance with the principles of the present invention; and

FIG. 2 is a flow chart of the overall process of the present invention.

### DETAILED DESCRIPTION OF THE PREFERRED EMBODIMENTS

The present invention advantageously presents a method and system for allowing a patient to receive discounted pharmaceuticals from a preventive healthcare program when the pharmaceuticals are prescribed by a physician who is not a member of the preventive healthcare program but enjoys a referral relationship with one or more physicians who are already qualified in the preventive healthcare program. Specifically, the present system and method determines the identity of the physician who has prescribed or who is associated with the prescription of pharmaceuticals to a patient who is eligible to prescribe medications through a preventive healthcare program. Through the electronic pharmacy claims adjudication process between the “contracted pharmacy” and the Pharmacy Benefit Management (PBM) company responsible for the adjudication of claims associated with the preventive care and drug discount programs, a query is made to determine if the physician who is associated with the prescription is a qualified member of the preventive healthcare program. If the physician is not a member of the program, a query is made of all member physicians to determine if any of the member physicians enjoy a referral relationship with the prescribing physician. If such a relationship exists, the prescribing physician is designated as “a qualified referral physician” and, along with the attending physician, may continue to be associated with the prescribing of pharmaceuticals to the patient under the terms of the preventive healthcare program.

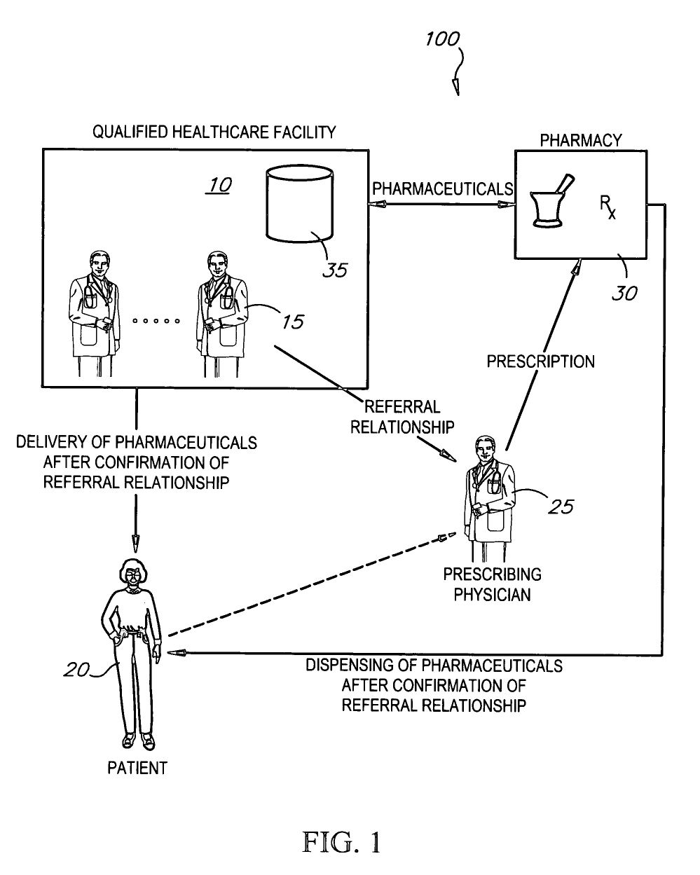

Referring now to the drawing figures in which like reference designators refer to like elements there is shown in FIG. 1 a system constructed in accordance with the principles of the present invention and designated generally as “100”. System 100 includes a qualified healthcare facility 10. It is preferred that healthcare facility 10 be qualified as a Federally Qualified Healthcare Center or Federally Qualified Healthcare Center Equivalent (both, for purposes of clarity, referred to as an “FQHC” in the present document), within the meaning of 42 U.S.C.§256(b), namely the Public Health Service Act, or a disproportionate share hospital, within the meaning of Title 1B of the Social Security Act.

Moreover, the Public Health Services Act also establishes a federal drug discount program under §340B. In order to benefit from this federal drug discount program and preferably the §340B drug discount program, a healthcare facility must be eligible for that benefit, such as by being qualified as an FQHC or disproportionate share hospital with attendant §340(b) qualifications. The description herein and associated drawing figures use the terms “federal drug discount program” and “preventive healthcare program” interchangeably.

Specifically, §340B requires pharmaceutical manufacturers, whose drugs are covered by the Medicaid program, to enter into a second agreement with the Secretary of Health and Human Services (HHS), whereby they would agree to provide discounts on covered drugs to specified government supported facilities. Among these government supported facilities are disproportionate share hospitals, owned or under contract with state or local governments, as well as specified grantees including FQHCs and qualified disproportionate share hospitals, according to the Public Health Service Act.

Along these lines, within the meaning of the method or system of the present invention, qualified healthcare facility 10 may include all or part of an FQHC or disproportionate share hospital, including a separate affiliate healthcare facility that is or becomes associated with a newly established or pre-established FQHC or disproportionate share hospital, and therefore becomes a qualified facility by virtue of the association.

For example, in one embodiment of the present invention, an already established healthcare center that qualifies as an FQHC or disproportionate share hospital can become associated with an affiliate healthcare center. This affiliate healthcare center can be commonly or independently owned and managed by being associated with and preferably operated by the FQHC or disproportionate share hospital. It will also retain FQHC or disproportionate share hospital status such that it would also be eligible for the federal discount drug program as an operating entity of the pre-established FQHC or disproportionate share hospital. Of course, it is recognized that a brand new entity, which is to be established as an FQHC or disproportionate share hospital can also be utilized, and/or the FQHC or disproportionate share hospital itself can internally expand or modify its services so as to independently define the qualified healthcare facility of the present invention.

In one embodiment, the pre-established FQHC or disproportionate share hospital is preferably, but not necessarily, an Indian Tribal Healthcare Facility established under the Indian Healthcare Act, and thus qualified as an FQHC eligible to participate in a federal drug discount program such as the §340B drug discount program. The qualified healthcare facility 10 is therefore appropriately defined. The healthcare facility 10 also preferably retains the services of at least one member physician 15, and typically a plurality of physicians 15 and associated staff which define individually and/or as a whole, a treatment staff of the healthcare facility 10.

Of course, it is understood that the treatment staff may include only a single physician, however, for purposes of providing the highest quality care to a patient, preferably a number of physicians and associated healthcare professionals and support personnel will be retained by healthcare facility 10. Additionally, in the preferred embodiments, at least one physician 15 retained by healthcare facility 10 will be telemedicine licensed.

The Federation of State Medical Boards has established criteria for telemedicine standards of practice, which many, if not all, states accept, and many states actually provide the telemedicine licensing. As a result, whether or not specific licensing is required, pursuant to the standards and practices of telemedicine or equivalent methods, by the state, in one embodiment of the invention, at least one physician will be telemedicine licensed so as to provide quality standards for telephony or remote communication with patient 40 as defined by the Federation of State Medical Board, and so as to ensure appropriate qualification of the physician(s) in those states that do require the licensing.

Referring again to FIG. 1, a patient 20 that is enrolled in the preventive healthcare program makes initial contact with healthcare facility 10 via either telephone, computer, or in-person in order to request discounted pharmaceuticals. However, patient 20 may already maintain a relationship with his or her personal physician 25. Patient 20 may feel more comfortable with their own personal physician 25 who has previously prescribed pharmaceuticals to the patient 20. Thus, upon an initial request by patient 20, healthcare facility 10 must determine if the patient's personal physician 25 maintains any referral relationship with one or more physicians 15 of healthcare facility 10.

Healthcare facility 10 may also contain a physician database 35, which contains the names of physicians that enjoy a referral relationship with one or more physicians 15 in healthcare facility 10 who are already qualified members of the preventive healthcare program. When it has been established that a member patient's personal physician 25 or a physician that is not a member of the preventive healthcare program has a referral relationship with a physician 15 who is already affiliated with the preventive healthcare program, physician 25 may prescribe pharmaceuticals at the discounted rate as if the pharmaceuticals had been prescribed by a member physician 15.

Referring o FIG. 1, when patient 20 has contacted facility 10 with a request for pharmaceuticals and has provided a name of a personal physician, facility 10 searches database 35 to determine if any member doctor 15 has a working relationship with the non-member physician. Database 35 may be updated to reflect referral physicians that are associated each member physician 15. Typically, each member physician 15 would be asked to list the names of physicians who they have referred patients to in the past and database 35 would be updated accordingly. It is contemplated that each member physician 15 may remove a non-member physician from the database if they have terminated their referral relationship or the member physician 15 feels that the non-member physician should not be considered in the program. Once healthcare facility 10 verifies that there is a referral relationship between the physicians, the non-member physician 25 may prescribe pharmaceuticals, and a pharmacy 30 may dispense the pharmaceuticals to the patient 20. Alternately, patient 20 make pick up the pharmaceuticals directly from healthcare facility 10.

Thus, in the above example, the present invention allows patients 20 that want to rely on their own personal physicians who are not members of the preventive healthcare program to nonetheless receive discounted pharmaceuticals at the discounted rate. Non-credentialed physicians may become referral physicians if a member physician enjoys a current referral relationship with them. In another embodiment, the relationship between the member physician 15 and the patient's personal physician 25 need not be a referral relationship, but may be any business relationship. For example, a member physician 15 may not have referred patients to physician 25, but may have worked with physician 25 in the past, may have been a mentor of physician 25, or may have established another type of business relationship.

Along these lines, physician 25 need not be the prior or personal physician of patient 20. When patient 20 seeks a prescription drug, he or she may contact a physician who is not a member of the preventive healthcare program. Patient 20 may meet with non-member physician 25, and physician 25 may prepare a prescription for the pharmaceutical. Alternately, physician 25 may recommend another physician or a specialist who ultimately prescribed the pharmaceuticals. Thus, physician 25 need not actually prescribe the pharmaceuticals but may be somehow associated with the prescription. In any case, the present invention ensures that physician 25 (as well as the physician that actually prescribed the drugs, if it were not physician 25) enjoys a current business relationship with one or more physicians 15 who are already members of the preventive healthcare program before pharmaceuticals can be dispensed to the patient 20 at the discounted rate.

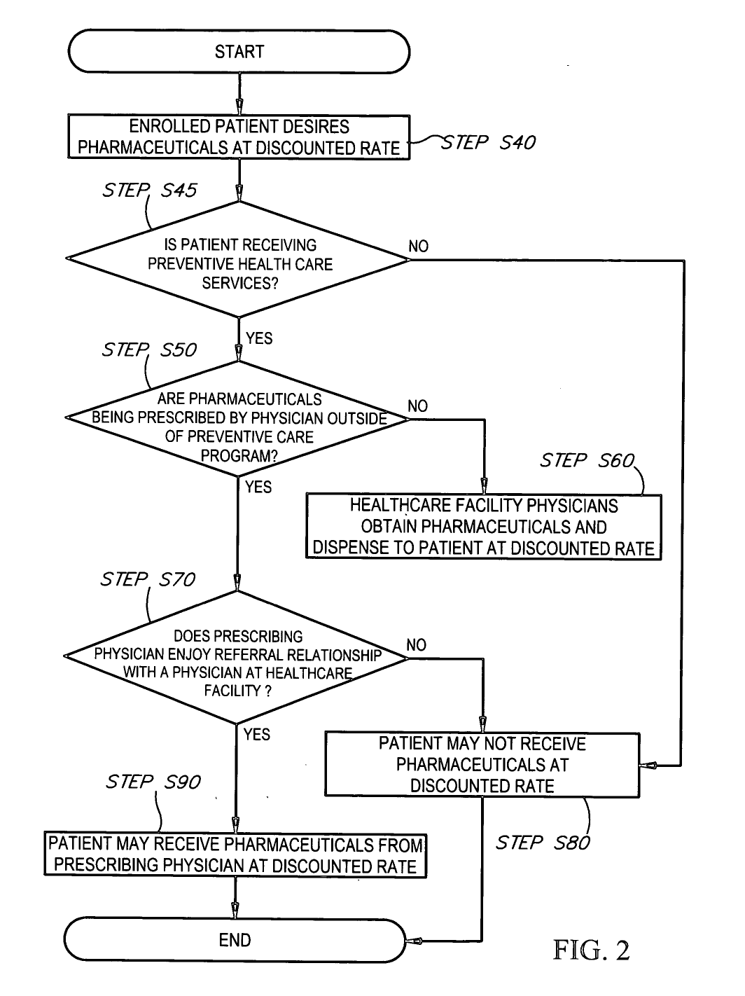

FIG. 2 illustrates the steps taken by preventive healthcare and prescription medication incentive compliance system and method system and method of the present invention. A patient 20 enrolled in the preventive healthcare program that seeks to obtain pharmaceuticals at a discounted rate contacts the healthcare facility 10, via step S40. The request may be supplied to healthcare facility 10 over the telephone, or the Internet, or by actually visiting healthcare facility 10. If it is determined that the patient is not receiving preventive health care services, via step S45, he or she is not entitled to receive pharmaceuticals at a discounted rate under the preventive healthcare program. If, however, the patient is receiving preventive health care, the patient may be eligible to receive discounted pharamecuticals.

Qualified healthcare facility 10 preferably obtains pharmaceuticals at a discounted cost utilizing the federal drug discount program. The qualified healthcare facility 10 may also appropriately dispense the pharmaceuticals obtained via the preventive healthcare program at a reduced cost to patient 20. Naturally, the pharmaceuticals will be dispensed to patient 20 under a prescription basis when necessary and in accordance with the one or more treatment programs associated with the qualified patient 20. Nevertheless, the reduced cost as defined herein may be defined as at least below a normal retail cost for the pharmaceuticals, and in many circumstances is substantially below the normal retail cost and below the cost that may otherwise be achieved utilizing a traditional pharmaceutical discount card type program.

As previously mentioned, it is recognized that the qualified healthcare facility 10 may be an affiliated healthcare facility that becomes associated with a pre-established or newly established FQHC or disproportionate share hospital, and/or a pre-established FQHC or disproportionate share hospital with which it becomes associated or which modifies or expands its services so as to define all or part of the qualified healthcare facility 10. Further, the qualified healthcare facility 10 may provide a number of different healthcare services to patients in addition to the chronic care case management services.

In this regard, it is noted that the disproportionate share hospital embodiments may not have any restriction to the type of eligible patient that may be treated or the type of service that may be provided. A treatment staff retained by qualified healthcare facility 10 is also included as part of the present system, that treatment staff preferably including at least one physician 15. Also in this regard, the treatment staff may be directly retained by the affiliated healthcare facility and/or the parent FQHC or disproportionate share hospital entity, nevertheless, that treatment staff will be deemed employees of the qualified healthcare facility 10 and therefore are able to effectively offer healthcare services via the qualified healthcare facility 10.

In certain scenarios, a patient 20 may wish to obtain pharmaceuticals through their own physician or through a physician that is not affiliated with the preventive healthcare program. For example, a patient may feel more comfortable with a physician that they have used in the past or who was recommended by a friend or family member yet who is not a qualified member of the discount program. Thus, it must first be determined if patient 20 is being prescribed the pharmaceuticals by a physician that is not a qualified member of the preventive healthcare program, at step S50. If patient 20 is using a physician 15 that is already a qualified member of the drug discount program, then healthcare facility 10 may dispense the pharmaceuticals at a discounted rate to patient 20 or contact a pharmacy 30 that will dispense the pharmaceuticals directly to patient 20 at a discounted rate, via step S60. If, however, patient 20 is using a non-member physician 25 either to prescribe the pharmaceuticals or to direct another physician to do so, it must be determined if physician 25 enjoys a business relationship with a physician 15 who is already a member of the drug discount program, via step S70. This is typically done by establishing a database 35 containing physician names and cross-referencing the non-member physician to determine if the physician's name is listed in database 35.

Database 35 contains the names of all physicians that currently have a relationship to one or more of the physicians 15 at healthcare facility 10. Typically, if a member physician 15 has referred patients to a non-member physician 25 in the past, the non-member physician will be listed as a “contact” of the member physician 15. In this fashion, non-member physicians 25 can be “credentialed” and patients may receive pharmaceuticals from the credentialed physician 25.

If it is determined that the physician 25 that patient 20 is using to obtain pharmaceuticals is not listed in database 35, then patient 20 cannot receive discounted pharmaceuticals from that non-member physician, via step S80. Healthcare facility 10 may, in the future, update database in order to include the non-member physician. Patient 20 may choose another physician who has established a referral relationship with one or more of the member physicians 15, or may simply use the physicians 15 that are already qualified members of the drug discount program.

However, if the non-member physician 25 associated with the pharmaceutical prescription is listed in database 35, patient 20 may receive pharmaceuticals from the prescribing physician, via step S90. Although the term “prescribing physician” is used to describe non-member physician 25, it is within the scope of the invention to define this physician as one who is associated with the dispensing or prescribing of the discounted pharmaceuticals and not necessarily the physician that actually prescribes the pharmaceuticals. Patient 20 may visit physician 25 for an examination and may then refer the patient to another physician, such as a specialist. The result may be a prescription of pharmaceuticals. If this is the case, in one embodiment, all the physicians that are associated with the prescribed pharmaceuticals are checked to determine, at step S70, if there is a referral relationship between a member physician 15 and each of the physicians that were associated with the prescribed drugs. Only if each of the non-member physicians enjoys a referral relationship with a member physician 15 can the pharmaceuticals be dispensed to patient 20 at the discounted rate.

Only certain types of healthcare facilities 10 are deemed FQHCs or disproportionate share hospitals, and are therefore eligible to participate in the federal drug discount program. In order to preserve FQHC or disproportionate share hospital status, when additional healthcare services are provided, either directly by the pre-established or newly established FQHC or disproportionate share hospital, or by the affiliated healthcare facility that becomes associated with the FQHC or disproportionate share hospital, the healthcare services that are provided must comply with the restrictions applicable to the FQHC or, in some cases, the disproportionate share hospital, for example, to be consistent with those services being offered when the facility was qualified as an FQHC or disproportionate share hospital in the first place.

As a result, if a particular FQHC or disproportionate share hospital has a dedicated specialization, healthcare services that are substantially different from that specialization may be inappropriate, and may jeopardize the eligibility of a patient receiving those healthcare services to participate in the federal drug discount program pharmaceuticals.

Looking further to the embodiment wherein the healthcare facility is qualified pursuant to the Indian Healthcare Act as an FQHC, the healthcare services to be offered to patients that are not part of the Indian population, in addition to being consistent with those services offered by Indian Tribal Healthcare facilities to members of the tribe, are also preferably performed in a manner which does not reduce or otherwise diminished services to the members of the tribe.

Moreover, in order to allow non-members of the tribe to receive services from the facility, the services, while consistent with existing services, are preferably not otherwise available, at least to the non-members of the tribe, in the operating area of the qualified healthcare facility. In any case, the healthcare facility must comply with the restrictions applicable to the FQHC or disproportionate share hospital.

Moreover, the treatment staff of healthcare facility 10 is preferably structured to remotely communicate with the patient 20, such as via the telephone or Internet, and preferably so as to obtain and maintain patient information which qualifies as a record of the patient's healthcare. Indeed, the treatment staff is structured to perform a patient contact sufficient to qualify the patient as a qualified patient of the qualified healthcare facility 10.

Although any number of different FQHC or disproportionate share hospitals may be provided to define the qualified healthcare facility 10 of the present system, in one embodiment, an Indian Tribal Healthcare Facility will act as the qualifying entity which can become associated with an affiliated healthcare center and/or can independently provide healthcare services and be deemed the qualified healthcare facility 10.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

We claim:

1. A method for providing a patient with access to pharmaceuticals via a preventive healthcare program, the pharmaceuticals being prescribed by a physician who is not a member of the preventive healthcare program, the method comprising:
(a) qualifying a healthcare facility as a disproportionate share hospital eligible to participate in the preventive healthcare program, the qualified healthcare facility associated with at least one qualified physician;
(b) determining if there is a relationship between the non-member physician and the at least one qualified physician; and
(c) if there exists a relationship between the non-member physician and the at least one qualified physician,
(d) providing pharmaceuticals to the patient at a discounted cost utilizing the preventive healthcare program.

2. The method of claim 1, wherein if there exists a relationship between the non-member physician and the at least one qualified physician, further comprising qualifying the non-member physician as a physician allowed to prescribe pharmaceuticals via the preventive healthcare program.

3. The method of claim 1, wherein if there does not exist a referral relationship between the non-member physician and the at least one qualified physician, notifying the patient that the non-member physician is not qualified to prescribe discounted pharmaceuticals under the preventive healthcare program.

4. The method of claim 1, wherein the healthcare facility is qualified as a disproportionate share hospital eligible to participate in the preventive healthcare program pursuant to section 340B of the Public Health Services Act.

5. The method of claim 1, wherein the healthcare facility maintains a database of non-member physicians such that determining if there is a relationship between the non-member physician and the at least one qualified physician includes matching the name of the non-member physician to the contents of the database.

6. The method of claim 1, further comprising establishing a communication between the qualified physician and the patient in order to establish a physician-patient relationship.

7. The method of claim 6, wherein the communication between the qualified physician and the patient is via the telephone.

8. The method of claim 6, wherein the communication between the qualified physician and the patient is via a computer network.

9. The method of claim 1, wherein the relationship between the non-member physician and the at least one qualified physician is a patient referral relationship.

10. A system for providing a patient with access to pharmaceuticals via a preventive healthcare program, the pharmaceuticals being prescribed by a physician who is not a member of the preventive healthcare program, the system comprising:
a healthcare facility, the healthcare facility qualifying as a disproportionate share hospital eligible to participate in the preventive healthcare program, the healthcare facility associated with at least one qualified physician; and
the healthcare facility adapted to determine if there is a relationship between one of the qualified physicians and the non-member physician, wherein if there is a relationship between one of the qualified physicians and the non-member physician, the patient may receive the prescribed pharmaceuticals at a reduced cost.

11. The system of claim 10, wherein if there is a relationship between the non-member physician and the at least one qualified physician, the non-member physician is identified as a physician qualified to prescribe pharmaceuticals at a reduced cost via the preventive healthcare program.

12. The system of claim 10, wherein if there does not exist a relationship between the non-member physician and the at least one qualified physician, the patient is notified that the non-member physician is not qualified to dispense pharmaceuticals at a discounted cost under the preventive healthcare program.

13. The system of claim 10, wherein the healthcare drug facility is qualified as a disproportionate share hospital eligible to participate in the preventive healthcare program pursuant to section 340B of the Public Health Services Act.

14. The system of claim 10, wherein the qualified physician and the patient establish a communication in order to create a physician-patient relationship.

15. The system of claim 14, wherein the communication between the qualified physician and the patient is via the telephone.

16. The system of claim 14, wherein the communication between the qualified physician and the patient is via a computer network.

17. The system of claim 10, wherein the relationship between the non-member physician and the at least one qualified physician is a patient referral relationship.

18. The system, of claim 10, wherein the healthcare facility maintains a database of non-member physicians such that it can be determined if there is a relationship between the non-member physician and the at least one qualified physician by matching the name of the non-member physician to the contents of the database.
